(19) United States
(12) Patent Application Publication
(10) Pub. No.: US 2006/0210696 A1
(43) Pub. Date: Sep. 21, 2006

(54) Slowly digestible carbohydrate

(76) Inventors: Chi-Li Liu, Decatur, IL (US); Richard W. Armentrout, Decatur, IL (US); Andrew J. Hoffman, Mount Zion, IL (US)

Correspondence Address: WILLIAMS, MORGAN & AMERSON, 10333 RICHMOND, SUITE 1100, HOUSTON, TX, 77042, US

(21) Appl. No.: 11/083,347

(22) Filed: Mar. 17, 2005

(51) Int. Cl. A23G 3/00

(52) U.S. Cl. 426/658

(57) ABSTRACT

A process for making an oligosaccharide composition comprises producing an aqueous composition that comprises at least one oligosaccharide and at least one monosaccharide by saccharification of starch, membrane filtering the aqueous composition to form a monosaccharide-rich stream and an oligosaccharide-rich stream, and recovering the oligosaccharide-rich stream. The oligosaccharide-rich stream is slowly digestible by the human digestive system, and can be used as a low-calorie food ingredient that is high in soluble dietary fiber.

### BACKGROUND OF THE INVENTION

A variety of carbohydrates are used in food products. Corn starch is one example. The carbohydrates in food products typically are digested in the human stomach and small intestine. Dietary fiber in food products, in contrast, is generally not digested in the stomach or small intestine, but may be at least partially bioconverted by microorganisms in the large intestine.

There is an interest in developing ingredients that are suitable for use in food products and that are either non-digestible or only digestible to a limited extent, in order to enhance the dietary fiber content or reduce the caloric content of the food. These modifications are thought to have certain health benefits.

There is a need for edible materials which have a reduced content of easily digestible carbohydrates, and which can be used in place of or in addition to conventional carbohydrate products in foods.

### SUMMARY OF THE INVENTION

One aspect of the invention is a process for making an oligosaccharide composition. The process comprises producing an aqueous composition that comprises at least one oligosaccharide and at least one monosaccharide by saccharification of starch; membrane filtering the aqueous composition to form a monosaccharide-rich stream and an oligosaccharide-rich stream; and recovering the oligosaccharide-rich stream. The oligosaccharide-rich stream is slowly digestible by the human digestive system. “Slowly digestible” as the term is used herein means that a substantial quantity (e.g., at least about 50% on a dry solids basis, and in some cases at least about 75%, or at least about 90%) of the carbohydrates present in the stream are either not digested at all in the human stomach and small intestine, or are only digested to a limited extent.

Both in vitro and in vivo tests can be performed to estimate rate and extent of carbohydrate digestion in humans. The “Englyst Assay” is an in vitro enzyme test that can be used to estimate the amounts of a carbohydrate ingredient that are rapidly digestible, slowly digestible or resistant to digestion (European Journal of Clinical Nutrition (1992) Volume 46 (Suppl. 2), pages S33-S50). Thus, any reference herein to “at least about 50% by weight on a dry solids basis” of a material being slowly digestible means that the sum of the percentages that are classified as slowly digestible or as resistant by the Englyst assay totals at least about 50%.

In one embodiment of the process, the aqueous composition that is produced by saccharification of starch, followed by isomerization, comprises dextrose, fructose, and a mixture of oligosaccharides. This aqueous composition can be nanofiltered to separate it into the monosaccharide-rich permeate stream and the oligosaccharide-rich retentate stream. The oligosaccharide-rich stream can comprise at least about 50% by weight oligosaccharides on a dry solids basis, or in some cases at least about 90%. In certain embodiments of the process, the oligosaccharide-rich stream will still comprise a minor amount of dextrose and fructose. “A minor amount” is used herein to mean less than 50% by weight on a dry solids basis.

The process, can, in some embodiments, also include one or more of the following steps: (1) contacting the oligosaccharide-rich stream with an isomerization enzyme, such that at least some of the dextrose is converted to fructose, thereby producing an isomerized oligosaccharide-rich stream; (2) membrane filtering the oligosaccharide-rich stream to produce a second monosaccharide-rich stream and a second oligosaccharide-rich stream that comprises more than about 90% by weight oligosaccharides on a dry solids basis as well as a minor amount of monosaccharides; (3) hydrogenating the oligosaccharide-rich stream to convert at least some of the monosaccharides therein to alcohols, thereby producing a hydrogenated oligosaccharide-rich stream; (4) contacting the oligosaccharide-rich stream with a glucosidase enzyme to create a reversion product such that at least some of any residual monosaccharides present in the stream are covalently bonded to oligosaccharides or other monosaccharides; and (5) reducing the color of the oligosaccharide-rich stream by contacting it with activated carbon.

Another aspect of the invention is an edible carbohydrate composition that comprises a major amount of oligosaccharides on a dry solids basis, and that is slowly digestible by the human digestive system. This composition can be produced by the above-described process. “Major amount” is used herein to mean at least 50% by weight on a dry solids basis.

In one embodiment, the edible carbohydrate composition is produced by a process as described above. In one particular embodiment, the oligosaccharide rich stream has a solids content not less than 70.0 percent mass/mass (m/m), and a reducing sugar content (dextrose equivalent), expressed as D-glucose, that is not less than 20.0 percent m/m calculated on a dry basis. This embodiment of the composition can be classified as corn syrup under food labeling regulations. In another embodiment, the oligosaccharide rich stream has a solids content not less than 70.0 percent mass/mass (m/m), and reducing sugar content (dextrose equivalent), expressed as D-glucose, less than 20.0 percent m/m calculated on a dry basis. This embodiment can be classified as maltodextrin under food labeling regulations.

Another aspect of the invention is a method of preparing a food product. The method comprises providing a food composition suitable for combination with a carbohydrate material, and combining the food composition with an edible carbohydrate composition that is slowly digestible, as described above.

### BRIEF DESCRIPTION OF THE DRAWING

FIG. 1 is process flow diagram of one embodiment of the present invention.

### DESCRIPTION OF SPECIFIC EMBODIMENTS

One aspect of the present invention is a process for making a slowly digestible carbohydrate composition that is suitable for use in foods. It should be understood that the term “food” is used in a broad sense herein to include a variety of other substances that can be ingested by humans, such as beverages and medicinal capsules or tablets.

The process can begin with a starch, for example a vegetable starch. Conventional corn starch is one suitable example. The process will generally operate more efficiently if the beginning starch has a relatively high purity. In one embodiment, the high purity starch contains less than 0.5% protein on a dry solids basis. Although some of the following discussion focuses on corn, it should be understood that the present invention is also applicable to starches derived from other sources, such as potato and wheat, among others.

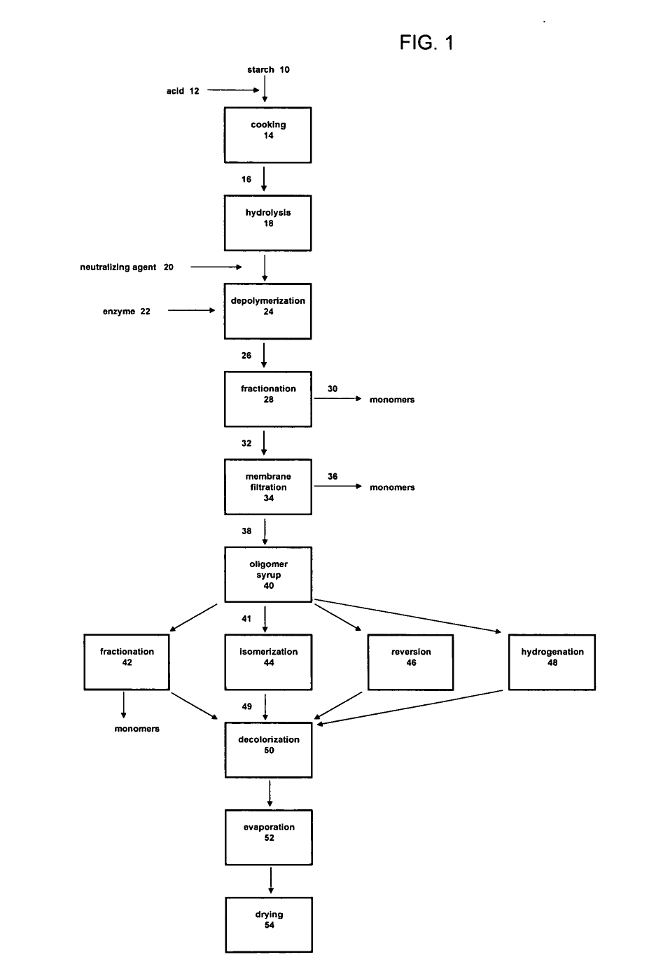

As shown in FIG. 1, the starch 10 can have acid 12 added to it and can then be gelatinized 14 in a starch cooker, for example in a jet cooker in which starch granules are contacted with steam. In one version of the process, the starch slurry, adjusted to a pH target of 3.5 by addition of sulfuric acid, is rapidly mixed with steam in a jet cooker and held at 149 to 152° C. (300 to 305° F.) for 4 minutes in a tail line. The gelatinized starch 16 is hydrolyzed 18 by exposure to acid at high temperature during jet cooking. The hydrolysis reduces the molecular weight of the starch and generates an increased percentage of monosaccharides and oligosaccharides in the composition. (The term “oligosaccharides” is used herein to refer to saccharides comprising at least two saccharide units, for example saccharides having a degree of polymerization (DP) of about 2-30.) A neutralizing agent 20, such as sodium carbonate, can be added to stop the acid hydrolysis, and then the composition can be further depolymerized 24 by contacting it with a hydrolytic enzyme 22. Suitable enzymes include alpha amylases such as Termamyl, which is available from Novozymes. This enzymatic hydrolysis further increases the percentage of monosaccharides and oligosaccharides present in the composition. The overall result of the hydrolysis by acid and enzyme treatment is to saccharify the starch. The saccharified composition can be isomerized to change the monosaccharide profile, for example to increase the concentration of fructose.

The saccharified composition 26 can then be purified, for example by chromatographic fractionation 28. In one embodiment that employs a sequential simulated moving bed (SSMB) chromatography procedure, a solution of mixed saccharides is pumped through a column filled with resin beads. Depending on the chemical nature of the resin, some of the saccharides interact with the resin more strongly leading to a retarded flow through the resin compared to saccharides that interact with the resin more weakly. This fractionation can produce one stream 30 that has a high content of monosaccharides, such as dextrose and fructose. High fructose corn syrup is an example of such a stream. The fractionation also produces a raffinate stream 32 that has a relatively high concentration of oligosaccharides (e.g., about 5- 15% oligosaccharides on a dry solids basis (d.s.b.)) and also contains a smaller concentration of monosaccharides such as dextrose and fructose. Although the term “stream” is used herein to describe certain parts of the process, it should be understood that the process of the present invention is not limited to continuous operation. The process can also be performed in batch or semi-batch mode.

The raffinate 32 can be further fractionated by membrane filtration 34, for example by nanofiltration, optionally with diafiltration. For example, these filtration steps can be performed using a Desal DK spiral wound nanofiltration cartridge at about 500 psi of pressure and at 40-60 degrees centigrade temperature. The fractionation described in step 34 could also be accomplished by sequential simulated moving bed chromatography (SSMB). The membrane filtration produces a permeate 36 which comprises primarily monosaccharides, and a retentate 38 which comprises primarily oligosaccharides. (“Primarily” as used herein means that the composition contains more of the listed component than of any other component on a dry solids basis.) The permeate 36 can be combined with the monomer stream 30 (e.g., high fructose corn syrup). The permeate is a monosaccharide-rich stream and the retentate is an oligosaccharide-rich stream. In other words, the nanofiltration concentrates the oligosaccharides in the retentate and the monosaccharides in the permeate, relative to the nanofiltration feed.

The retentate 38, which can be described as an oligosaccharide syrup 40, can have a sufficiently high content of oligosaccharides that are slowly digestible (e.g., at least about 50% by weight d.s.b., or in some cases at least about 90%) so that it can be dried or simply evaporated to a concentrated syrup and used as an ingredient in foods. However, in many cases, it will be useful to further process and purify this composition. Such purification can include one or more of the following steps. (Although FIG. 1 shows four such purification steps 42, 44, 46, and 48 as alternatives, it should be understood that two or more of these steps could be used in the process.)

One option is to subject the oligomers syrup 40 to another fractionation 42, such as a membrane filtration, for example a second nanofiltration, in order to remove at least some of the residual monosaccharides, such as fructose and dextrose. Suitable nanofiltration conditions and equipment are as described above. This nanofiltration produces a permeate, which is a second monosaccharide-rich stream, which can be combined with the monomer stream 30. Alternatively, the further fractionation 42 could be done by chromatographic separation, for example, by simulated mixed-bed chromatography.

Another option is to isomerize 44 the syrup 41 by contacting it with an enzyme such as glucose isomerase. This will convert at least some of the residual dextrose present into fructose, which may be more valuable in certain situations.

Another option is to treat the syrup with an enzyme to cause reversion or repolymerization 46, in which at least some of the relatively small amounts of monosaccharides that are still present are covalently bonded to other monosaccharides or to oligosaccharides, thereby reducing the residual monomer content of the syrup even further. Suitable enzymes for use in this step include glucosidases, such as amylase, glucoamylase, transglucosidase, and pullulanase. Cellulase enzymes may produce valuable reversion products for some applications.

Yet another option is to hydrogenate 48 the syrup to convert at least some of any residual monosaccharides to the corresponding alcohols (e.g., to convert dextrose to sorbitol). When hydrogenation is included in the process, it will typically (but not necessarily) be the final purification step.

The purified oligomer syrup 49 produced by one or more of the above purification steps can then be decolorized 50. Decolorization can be done by treatment with activated carbon followed by microfiltration, for example. In continuous flow systems, syrup streams can be pumped through columns filled with granular activated carbon to achieve decolorization. The decolorized oligomer syrup can then be evaporated 52, for example to about greater than about 70% dry solids (d.s.), giving a product that comprises a high content of oligosaccharides (e.g., greater than 90% by wt d.s.b., and in some instances greater than 95%), and a correspondingly low monosaccharide content. The product comprises a plurality of saccharides which are slowly or incompletely digested by humans, if not totally indigestible. These sugars can include isomaltose, panose and branched oligomers having a degree of polymerization of four or greater.

The process conditions can be modified to recover the majority of the maltose in the feed either in the monomer-rich streams (30, 36) or in the oligomer product stream. For example, a nanofiltration membrane with a slightly more open pore size, such as Desal DL, operating at less than 500 psi pressure can be used to increase the amount of maltose in monomer-rich streams.

The product is suitable as an ingredient for foods, and is slowly digestible by the human digestive system. As mentioned above, some components of the product can be substantially entirely indigestible in the human stomach and small intestine. Depending on the starch source used, the product can be classified in some embodiments as corn syrup or wheat syrup, as those terms are used in food labeling. In cases where more open pore sizes are used in nanofiltration, a higher molecular weight oligomer syrup product classified as a maltodextrin can be obtained.

The oligosaccharide-containing syrup produced by the process can be added to foods as replacement or supplement for conventional carbohydrates. Specific examples of foods in which the syrup can be used include processed foods such as bread, cakes, cookies, crackers, extruded snacks, soups, frozen desserts, fried foods, pasta products, potato products, rice products, corn products, wheat products, dairy products, yogurts, confectioneries, hard candies, nutritional bars, breakfast cereals, and beverages. A food product containing the oligosaccharide syrup will have a lower glycemic response, lower glycemic index, and lower glycemic load than a similar food product in which a conventional carbohydrate, such as corn starch, is used. Further, because at least some of the oligosaccharides are either only digested to a very limited extent or are not digested at all in the human stomach or small intestine, the caloric content of the food product is reduced. The syrup is also a source of soluble dietary fiber.

The process described herein takes advantage of a fraction of the saccharide syrup (e.g., stream 26 in FIG. 1) that is resistant to saccharification. By separating this material as a purified product, it can be employed for its own useful properties, rather than being an undesirable by-product in syrups that are primarily monosaccharides, such as high fructose corn syrup. Removal of a greater percentage of the oligosaccharides from the high fructose corn syrup allows that product to be made purer (i.e., with a higher concentration of dextrose and fructose) and thus more valuable.

### EXAMPLE 1

Raffinate syrup was obtained from a plant in which corn starch was being processed into high fructose corn syrup. The raffinate was produced by a chromatographic separation, and comprised primarily fructose and dextrose. The raffinate was subjected to nanofiltration using a Desal DK1812C-31D nanofiltration cartridge at about 500 psi of pressure and at a temperature of 40-60° C. The retentate from the nanofiltration was decolorized with activated charcoal, and then evaporated to approximately 80% dry solids. A saccharide analysis of the dry product was performed by HPAE-PAD chromatography, and the results are shown in Table 1.

TABLE 1

| Component | Wt % d.s.b. |
|---|---|
| dextrose | 38.9% |
| fructose | 6.1% |
| isomaltose | 14.3% |
| maltose | 10.5% |
| maltotriose | 0.3% |
| panose | 9.5% |
| linear higher saccharides | 0.0% |
| nonlinear higher | 20.4% |
| saccharides | |

This material, termed Light Raffinate, was tested for digestibility using an Englyst assay. About 600 mg of carbohydrate d.s.b was added to 20 mL of 0.1 M sodium acetate buffer in a test tube. The contents were mixed and then heated to about 92° C. for 30 minutes, then cooled to 37° C. Then 5 mL of enzyme solution was added to the test tube and it was agitated by shaking in a water bath at 37° C. Small samples were removed at both 20 min and 120 min. The enzyme was inactivated, the samples were filtered and measured for digestibility using a glucose test from YSI Inc. A Heavy Raffinate, processed in a separate but similar nanofiltration operation, was also tested using the same assay. The Heavy Raffinate contained 25-35% dry solids, as opposed to 15-25% dry solids for the Light Raffinate, but both had approximately the same percentage of low molecular weight saccharides. A cooked potato starch, which had not been nanofiltered, was also tested as a comparison. The results of the digestibility assay and a saccharide analysis are shown in Table 2. Cooked potato starch is included in Table 2 for comparison. All percentages in Table 2 are on a d.s.b.

TABLE 2

| | % rapidly | % slowly | | % monosaccharides | % oligosaccharides |
|---|---|---|---|---|---|
| material | digestible | digestible | % resistant | (by HPAE) | (by HPAE) |
| Light raffinate | 45 | 3 | 52 | 45 | 55 |
| Heavy raffinate | 41 | 3 | 56 | 44 | 56 |
| Potato starch | 78 | 11 | 11 | 44 | 56 |
| (cooked) | | | | | |

There was an excellent correlation between the percentage of oligosaccharides in the material and the percentage of the material that was resistant to digestion.

### EXAMPLE 2

About 1,025 L of raffinate syrup at 21.4% dry solids was obtained from a plant in which corn starch was being processed into high fructose corn syrup. The raffinate was produced by a chromatographic separation, and comprised primarily fructose and dextrose. The raffinate was subjected to nanofiltration using two Desal NF3840C-50D nanofiltration cartridges at about 500 psi of pressure and at a temperature of 40-60° C. After the starting volume was reduced by about a factor of 20, the retentate was subjected to about 2 volumes of constant volume diafiltration using DI water. After diafiltration, 27.6 kg of retentate product (at 33.8% ds) was collected. This material was decolorized with activated carbon (0.5% by weight of syrup solids) by stirring in a refrigerator overnight. This slurry was sterilized by filtration through a 0.45 micron hollow fiber filtration cartridge, and evaporated in parts to an average concentration of about 73% ds.

A saccharide analysis of the dry product was performed by HPAE-PAD chromatography, and the results are shown in Table 3.

TABLE 3

| Component | Wt % d.s.b. |
|---|---|
| dextrose | 4.5% |
| fructose | 0.9% |
| isomaltose | 20.6% |
| maltose | 23.5% |
| maltotriose | 0.4% |
| panose | 20.9% |
| linear higher saccharides | 0.0% |
| nonlinear higher | 29.1% |
| saccharides | |

The preceding description of specific embodiments of the invention is not intended to be a list of every possible embodiment of the invention. Persons skilled in the art will recognize that other embodiments would be within the scope of the following claims.

What is claimed is:

1. A process for making an oligosaccharide composition, comprising:
producing an aqueous composition that comprises at least one oligosaccharide and at least one monosaccharide by saccharification of starch;
fractionating the aqueous composition by a method comprising at least one of membrane filtering and sequential simulated moving bed chromatography to form a monosaccharide-rich stream and an oligosaccharide-rich stream; and
recovering the oligosaccharide-rich stream.

2. The process of claim 1, wherein the aqueous composition comprises dextrose, fructose, and a mixture of oligosaccharides.

3. The process of claim 1, wherein the oligosaccharide-rich stream comprises at least about 50% by weight oligosaccharides on a dry solids basis.

4. The process of claim 3, wherein the oligosaccharide-rich stream comprises at least about 90% by weight oligosaccharides on a dry solids basis.

5. The process of claim 1, wherein the fractionation comprises nanofiltration.

6. The process of claim 1, wherein the fractionation is performed by sequential simulated moving bed chromatography (SSMB).

7. The process of claim 1, wherein the oligosaccharide-rich stream comprises a minor amount of dextrose and fructose, and wherein the process further comprises contacting the oligosaccharide-rich stream with an isomerization enzyme such that at least some of the dextrose is converted to fructose, thereby producing an isomerized oligosaccharide-rich stream.

8. The process of claim 1, further comprising membrane filtering the oligosaccharide-rich stream to produce a second monosaccharide-rich stream and a second oligosaccharide-rich stream.

9. The process of claim 8, wherein the second oligosaccharide-rich stream comprises more than about 90% by weight oligosaccharides on a dry solids basis.

10. The process of claim 1, wherein the oligosaccharide-rich stream comprises a minor amount of monosaccharides, and wherein the process further comprises hydrogenating the oligosaccharide-rich stream to convert at least some of the monosaccharides therein to alcohols, thereby producing a hydrogenated oligosaccharide-rich stream.

11. The process of claim 8, wherein the second oligosaccharide-rich stream comprises a minor amount of monosaccharides, and wherein the process further comprises hydrogenating the second oligosaccharide-rich stream to convert at least some of the monosaccharides therein to alcohols, thereby producing a hydrogenated oligosaccharide-rich stream

12. The process of claim 1, further comprising contacting the oligosaccharide-rich stream with a glucosidase enzyme such that at least some of any residual monosaccharides present in the stream are covalently bonded to oligosaccharides or other monosaccharides.

13. The process of claim 1, further comprising reducing the color of the oligosaccharide-rich stream by contacting it with activated carbon.

14. The process of claim 1, wherein the oligosaccharide-rich stream is slowly digestible by the human digestive system.

15. The process of claim 1, wherein the fractionation comprises nanofiltration, the aqueous composition comprises dextrose, fructose, and a mixture of oligosaccharides, and the oligosaccharide-rich stream comprises a minor amount of dextrose and fructose, and wherein the process further comprises at least one of the following:
contacting the oligosaccharide-rich stream with an isomerization enzyme such that at least some of the dextrose is converted to fructose;
membrane filtering the oligosaccharide-rich stream;
hydrogenating the oligosaccharide-rich stream to convert at least some of the monosaccharides therein to alcohols;
contacting the oligosaccharide-rich stream with a glucosidase enzyme to create a reversion product such that at least some of any residual monosaccharides present in the stream are covalently bonded to oligosaccharides or other monosaccharides; and
reducing the color of the oligosaccharide-rich stream by contacting it with activated carbon;
wherein the oligosaccharide-rich stream is slowly digestible by the human digestive system.

16. An edible carbohydrate composition that comprises a major amount of oligosaccharides on a dry solids basis, and that is slowly digestible by the human digestive system.

17. The composition of claim 16, wherein the composition is produced by a process comprising:
producing an aqueous composition that comprises at least one oligosaccharide and at least one monosaccharide by saccharification of starch;
fractionating the aqueous composition by a method comprising at least one of membrane filtering and sequential simulated moving bed chromatography to form a monosaccharide-rich stream and an oligosaccharide-rich stream; and
recovering the oligosaccharide-rich stream.

18. The composition of claim 17, wherein the aqueous composition comprises dextrose, fructose, and a mixture of oligosaccharides.

19. The composition of claim 17, wherein the fractionation comprises nanofiltration.

20. The composition of claim 17, wherein the fractionation comprises nanofiltration, the aqueous composition comprises dextrose, fructose, and a mixture of oligosaccharides, and the oligosaccharide-rich stream comprises a minor amount of dextrose and fructose, and wherein the process further comprises at least one of the following:
contacting the oligosaccharide-rich stream with an isomerization enzyme such that at least some of the dextrose is converted to fructose;
membrane filtering the oligosaccharide-rich stream;
hydrogenating the oligosaccharide-rich stream to convert at least some of the monosaccharides therein to alcohols;
contacting the oligosaccharide-rich stream with a glucosidase enzyme to create a reversion product such that at least some of any residual monosaccharides present in the stream are covalently bonded to oligosaccharides or other monosaccharides; and
reducing the color of the oligosaccharide-rich stream by contacting it with activated carbon.

21. The composition of claim 17, wherein the oligosaccharide rich stream has a solids content not less than 70.0 percent mass/mass (m/m), and reducing sugar content (dextrose equivalent), expressed as D-glucose, that is not less than 20.0 percent m/m calculated on a dry basis.

22. The composition of claim 17, wherein the oligosaccharide rich stream has a solids content not less than 70.0 percent mass/mass (m/m), and reducing sugar content (dextrose equivalent), expressed as D-glucose, less than 20.0 percent m/m calculated on a dry basis.

23. A method of preparing a food product, comprising:
providing a food composition suitable for combination with a carbohydrate material;
combining the food composition with an edible carbohydrate composition of claim 16.
